(19) United States
(12) Patent Application Publication
(10) Pub. No.: US 2002/0035878 A1
(43) Pub. Date: Mar. 28, 2002

(54) Seat belt tension sensor

(76) Inventor: Peter Norton, Farmington, MI (US)

Correspondence Address: Peter Norton, Post Office Box 62, Northville, CA, 48167, US

(21) Appl. No.: 09/992,072

(22) Filed: Nov. 5, 2001

Related U.S. Application Data
(63) Continuation-in-part of application No. 09/625,765, filed on Jul. 26, 2000, now Pat. No. 6,311,571.
Application No. 09/625,765 is a continuation-in-part of application No. 09/592,237, filed on Jun. 12, 2000.
Application No. 09/592,237 is a continuation-in-part of application No. 09/565,703, filed on May 4, 2000.
Application No. 09/565,703 is a continuation-in-part of application No. 09/547,482, filed on Apr. 12, 2000.
Application No. 09/547,482 is a continuation-in-part of application No. 09/495,212, filed on Jan. 31, 2000.

(51) Int. Cl. G01L 1/26

(52) U.S. Cl. 73/862.391

(57) ABSTRACT

A seat belt tension sensor has an anchor, a seat belt tension receiver, a moving arm force responder, and an arm sensor. The seat belt tension receiver applies force from a seat belt to the force responder. The force responder is made of spring metal bent to have a base for receiving force and one or two arms that are urged to move by the received force. The arm sensor responds to the arm or arms by generating an electric signal. The anchor has an opening through which a seat belt, the seat belt tension receiver and the force responder pass. A cross member of the anchor spans the opening and withstands the large forces applied by the seat belt when the vehicle strikes an obstacle. An edge of the cross member is grooved to engage the base of the force responder in a way that provides low friction during flexing of the base. The base of the force responder operates as a low friction bearing for the movement of the seat belt tension receiver. A flexible suspension element made of spring metal operates as a second bearing and also operates as a preloading spring. In a preferred embodiment, the arm sensor comprises a semiconductor capacitance sensor responsive to the capacitance between two capacitor plates and two arms of a force responder. In a second preferred embodiment, the arm sensor comprises two permanent magnets movable with the arms of a force responder and a magnetic field sensor.

This is a continuation-in-part of application Ser. No. 09/625,765 filed Jul. 26, 2000 and titled SEAT BELT TENSION SENSOR which is a continuation-in-part of application Ser. No. 09/592,237 filed Jun. 12, 2000 and titled SEAT BELT TENSION SENSOR which is a continuation-in-part of application Ser. No. 09/565,703 filed May 4, 2000 and titled SEAT BELT TENSION SENSING SYSTEM which is a continuation-in-part of application Ser. No. 09/547,482 filed Apr. 12, 2000 and titled SEAT BELT TENSION SENSING SYSTEM which is a continuation-in-part of application Ser. No. 09/495,212 flied Jan. 31, 2000 and titled SEAT OCCUPANT WEIGHT SENSING SYSTEM.

### FIELD OF THE INVENTION

This invention relates to systems that ascertain what is occupying a vehicle seat for deciding if and how air bags should be deployed.

### BACKGROUND OF THE INVENTION

Air bags of occupant protection systems are expensive and in certain circumstances are dangerous. It is therefore desirable to avoid deployment when the seat is empty to save the cost of replacement. It is desired to avoid deployment when circumstances do not warrant deployment or when deployment might do more harm than good. It is particularly important to deploy the airbag judiciously when the seat is occupied by a child or by a very small adult. A system is desired to reliably distinguish an adult from a child even when the child is in a child seat and belts retaining the child seat are under substantial tension.

Occupant protection systems typically include a “sensor and diagnostic modules” or “SDM” which senses the severity of a vehicle crash, monitors elements of the occupant protection system for proper operation, and deploys occupant protection devices. SDMs typically include a microprocessor, an accelerometer, an arming sensor, circuitry interconnecting the aforementioned components and switches for initiating deployment of the occupant protection devices. SDMs may be connected for receiving input from other sensors responsive to aspects of the occupancy of the seat.

To optimally deploy an airbag the SDM must take into account the weight of a seat occupant. Seat occupant weight sensors sense the weight of the occupant and communicate that weight to the SDM. With certain known seat occupant weight sensing systems seat belt tension affects the weight measurement therefore, for those systems, seat belt tension must be measured and communicated to a microprocessor of the SDM.

Capacitance sensing semiconductors are made by Quantum Research Group of Pittsburgh, Pa. and others. These devices sense small capacitances and certain of the capacitance sensing semiconductors provide outputs that varies linearly or monotonically with the capacitance being sensed.

A seat belt tension sensor must meet certain requirements: For accuracy and long life, friction in the mechanism must be minimized. The sensor must be accurate over a wide range of temperatures. The sensor must not rattle when the roads are rough. The seat belt tension sensor mechanism must with-stand about one thousand pounds of seat belt force repeatedly without damage and not fracture or otherwise fail to restrain the occupant under about four thousand pounds of seat belt force, which could occur when the vehicle collides with an obstacle. No known belt tension sensor meets these requirements at a low cost.

Known force sensors must be protected from forces greatly in excess of the forces they are designed to measure. A seat belt tension sensor incorporating a known force sensor must protect the force sensor from the large forces that sometimes occur. Providing protection adds to the cost and complexity of the seat belt tension sensor. Accordingly, a force sensor that can measure forces on the order of thirty pounds while not being damaged by forces on the order of one thousand pounds is desired.

Of the known distance sensing means, capacitance sensing is advantageous for being inherently insensitive to temperature, not requiring permanent magnets, and being insensitive to the material used for sensing elements.

A general object of this invention is to provide a seat belt tension sensor offering low cost and superior performance which also overcomes certain disadvantages of the prior art.

### SUMMARY OF THE INVENTION

In accordance with the invention, a new mechanism enables a low cost seat belt tension sensor. The mechanism comprises an anchor, a seat belt tension receiver, a moving arm force responder, and a preloading spring. The moving arm force responder comprises a base unitary with one or two arms. The tension receiver operates to apply force derived from seat belt tension to the base thereby causing the base to flex and the arm or arms to move. A sensor responsive to arm position provides an electric signal indicating seat belt tension.

Further, in accordance with the invention, the anchor comprises a flat plate having an opening for receiving a seat belt, the seat belt tension receiver and the moving arm force responder. A cross member of the anchor spans one side of the opening. The cross member withstands the largest seat belt forces encountered during a collision.

Further, in accordance with the invention an edge of the cross member has a groove with salient edges engaging the base of the moving arm force responder. Friction between the cross member and the moving arm force responder is minimized by designing the salient edges and the base of the moving arm force responder to minimize or eliminate relative movement therebetween while the base flexes, whereby long life and low hysteresis are achieved.

Further, in accordance with the invention, a moving arm force responder comprising two arms unitary with a flexible base, combined with a position sensor enables a superior and lower cost seat belt tension sensor that leads to a first moving arm position sensor responsive to capacitance.

Further, in accordance with the invention, the moving arm position sensor comprises a semiconductor capacitance sensor responsive to capacitance between a capacitor plate and an arm of the moving arm force responder. When the base of the moving arm force responder flexes under the applied force and the arm moves, the capacitance between the capacitor plate and the arm of the moving arm force responder is changed. The seat belt tension is computed from the output of the capacitance sensor.

Further, in accordance with the aforementioned moving arm position sensor, an arm of the moving arm force responder moves sufficiently in response to forces less than thirty pounds to enable a capacitive distance sensor to respond to the movement. Under larger forces the base of the moving arm force responder “bottoms out” against the groove of the cross member, thereby being protected from being stressed to its yield stress.

Further, in accordance with the aforementioned moving arm position sensor, the moving arm force responder comprises a pair of arms, and the distance sensor comprises two capacitor plates fixed with respect to the anchor. One capacitor plate is parallel to and in close proximity to one arm of the moving arm force responder. Whereupon, by the laws of Physics, there is a first capacitance therebetween. The other capacitor plate is parallel to and in close proximity to the other arm of the moving arm force responder, whereupon there is a second capacitance therebetween. The capacitance sensor senses the capacitance between the two capacitor plates, which is substantially the series capacitance of the aforementioned first and second capacitances. When seat belt tension is applied, the base of the tension receiver flexes to increase the distance between the arms which decreases the series capacitance.

Further, in accordance with the aforementioned moving arm position sensor, the series capacitance is substantially determined by the distance between the arms of the moving arm force responder and not by the position of the capacitor plates, which are fixed with respect to the anchor. In other words, the series capacitance is only slightly affected if the two capacitor plates become located to one side or the other of the central position between the arms. Accordingly, the measured capacitance is substantially dependent on the distance between the arms and not to where the capacitor plates happen to be.

Further, in accordance with a second moving arm position sensor, the distance sensor comprises a permanent magnet and a magnetic field sensor responsive to a magnetic field between a the permanent magnet and the arms of the moving arm force responder. When the base of the moving arm force responder flexes under the applied force and the arms move, the magnetic field changes. The seat belt tension is computed from the output of the magnetic field sensor.

Further, in accordance with the aforementioned second moving arm position sensor, an arm of the moving arm force responder moves sufficiently in response to forces less than thirty pounds to enable the magnetic field sensor to provide a measure of the movement. Under larger forces the base of the moving arm force responder “bottoms out” against the groove of the cross member, thereby being protected from being stressed to its yield stress.

Further, in accordance with the invention, the moving arm force responder is able to repeatedly withstand seat belt forces greater than one thousand pounds applied to its flexible base without damage thereby remaining responsive to seat belt tension between zero and thirty pounds.

Therefore, the invention satisfies the unmet need for a low cost seat belt tension sensor responsive to small seat belt tensions while being able to withstand large seat belt tensions.

Further, in accordance with the invention, the electric signal produced by the sensor responsive to arm position is transmitted to elements of the occupant protection system and used for estimating the weight of a seat occupant.

Further, in accordance with the invention, a low friction bearing between the seat belt tension receiver and the anchor comprises spring metal cut from sheet stock to engage the upper part of the tension receiver and the anchor. In its unstressed state the bearing is arched so that flattening it provides a preload force during normal operation that keeps the anchor, moving arm force responder and tension receiver in contact with each other to prevent rattling.

Further, in accordance with the invention, the tension receiver is formed to have four sides which surround the cross member of the anchor, the moving arm force responder, and the middle portion of the preload spring.

Further, in accordance with the invention, the base of the moving arm force responder also operates as a second bearing between the tension receiver and the anchor. The second bearing is formed by a protrusion of the seat belt tension receiver engaging the middle of the base of the moving arm force responder. The aforementioned first bearing and the second bearing operate in concert to allow axial movement and prevent cross axis movement. The two bearings together have sufficiently low friction that when seat belt tension is applied at large angles to the seat belt tension sensor axis the tension sensor accurately measures the axial component of the seat belt tension.

Further, in accordance with the invention, all electrical components including the distance sensor are incorporated into a single plastic molding. The molding may also include an enclosure that isolates the moving arm force responder and capacitor plates from contamination from outside the seat belt tension sensor.

Further, in accordance with the invention, the distance sensor is manufactured as an assembly unitary with an electrical connector. This results in particularly simple manufacture in which all electrical elements are manufactured into a single assembly.

A complete understanding of this invention may be obtained from the description that follows taken with the accompanying drawings.

### DESCRIPTION OF THE DRAWINGS

FIG. 1 shows a frontal view of the seat belt tension sensor of the invention.

FIG. 2 shows a side view of the seat belt tension sensor of the invention illustrated in FIG. 1 partially in section taken at section 2-2 of FIG. 1. FIG. 2 also illustrates axial and cross axis directions.

FIG. 3 shows the seat belt tension sensor of the invention illustrated in FIG. 1 partially in section taken at section 3-3 of FIG. 2.

FIG. 4 shows the seat belt tension sensor of the invention illustrated in FIG. 1 partially in section taken at section 4-4 of FIG. 2.

FIG. 5 shows in a plan view the preload spring which is also the upper bearing of the seat belt tension sensor of the invention.

FIG. 6 shows a view of the back of the seat belt tension sensor of the invention with certain electrical parts illustrated by hidden lines.

FIG. 7 shows a view of the top of the seat belt tension sensor of the invention.

FIG. 8 shows an enlargement of the top portion of the seat belt tension sensor of the invention as illustrated in FIG. 2.

FIG. 9 shows the top portion of the seat belt tension sensor of the invention illustrated in FIG. 8 when large seat belt tension is applied.

FIG. 10 shows a perspective view of the plastic molding of the seat belt tension sensor of the invention with part of the enclosure cut away, and with certain of the electrical parts illustrated by hidden lines.

FIG. 11 shows the top portion of additional embodiments of the seat belt tension sensor of the invention when seat belt tension is zero.

FIG. 12 shows the top portion of additional embodiments of the seat belt tension sensor of FIG. 11 during nonzero seat belt tension.

### BEST MODE FOR CARRYING OUT THE INVENTION

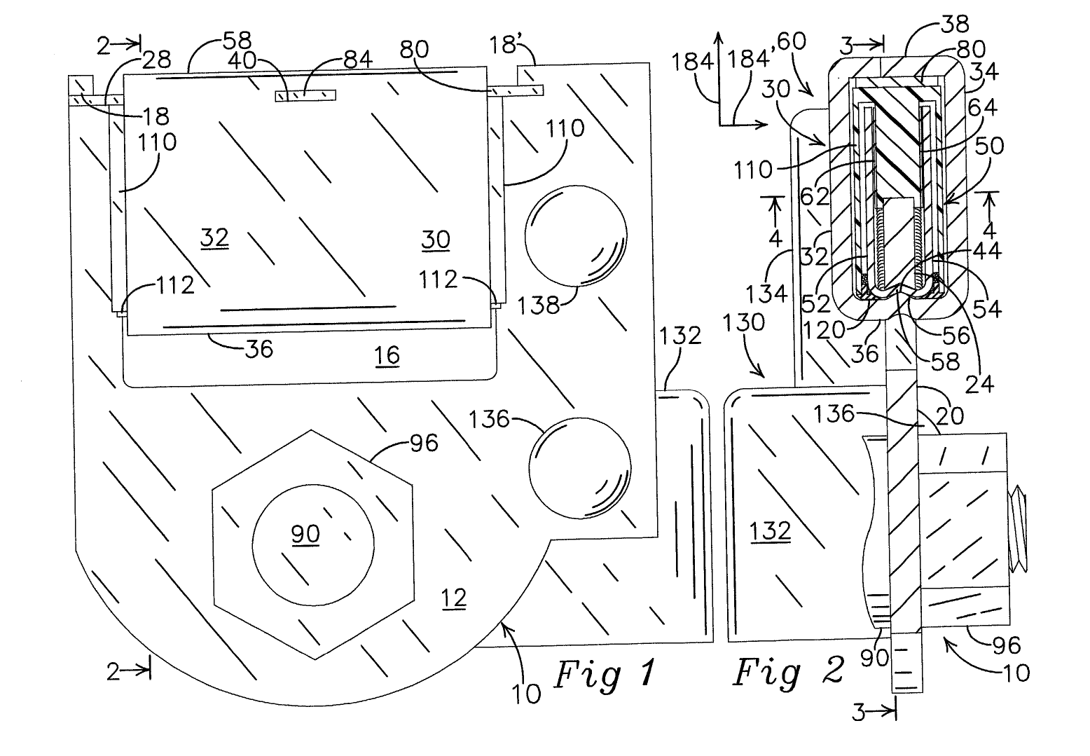

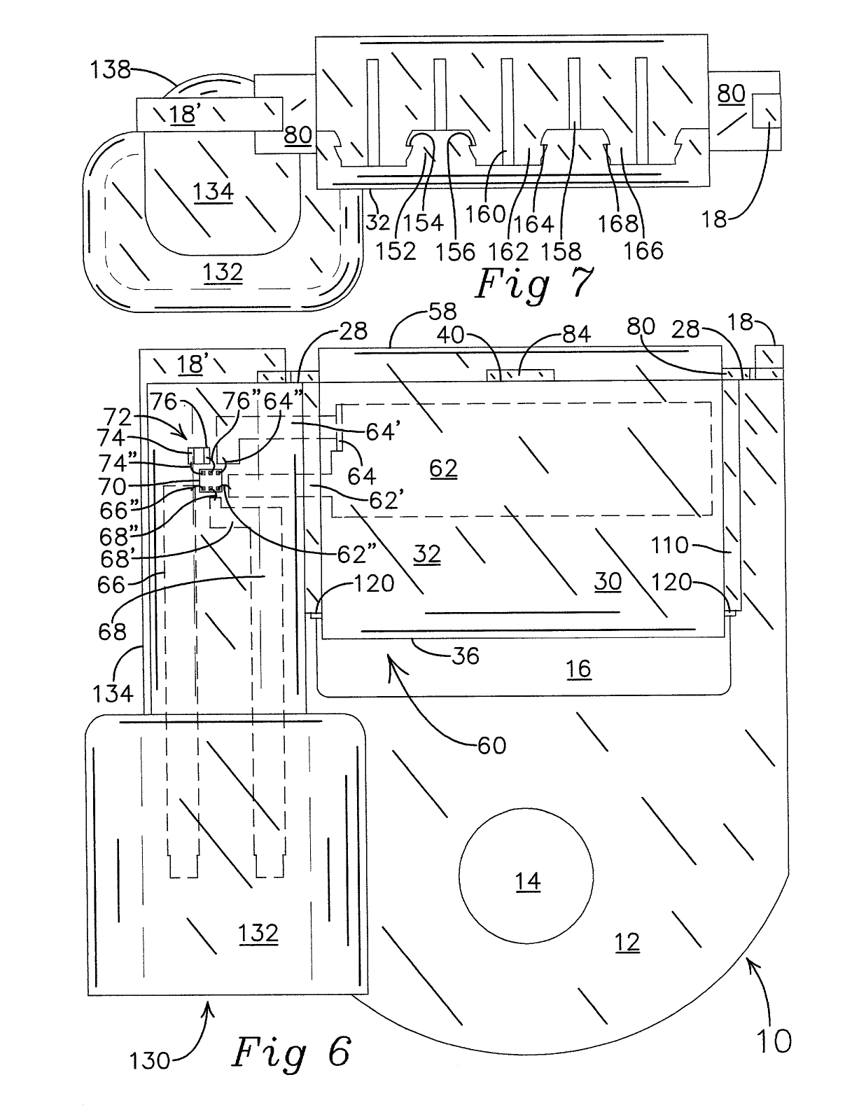

Proceeding first with reference to FIGS. 2 and 6, seat belt tension sensor 10 provides a signal through connector pins 66 and 68 to an occupant weight sensing system (not illustrated) indicating the axial component of tension in a seat belt. Seat belt tension sensor 10 comprises anchor 12, seat belt tension receiver 30, moving arm force responder 50, connector and distance sensor 60, and bearing and preload spring 80. Anchor 12 is rotatably attached to shouldered stud 90. Shouldered stud 90 is attached to a part of the vehicle able to withstand large forces. Tension receiver 30 receives force from a seat belt and applies the axial component of the received force to moving arm force responder 50. The arms of moving arm force responder 50 move farther apart when force is applied. Connector and distance sensor 60 responds to the distance between the arms of moving arm force responder 50 by providing the aforementioned electric signal. Preload spring 80 operates as a bearing to prevent friction between tension receiver 30 and anchor 12 in the presence of cross axis forces and also provides preload force to prevent rattles. (“cross axis” is used herein to denote directions perpendicular to the axis indicated by arrow 184 in FIG. 2)

A moving arm position sensor comprising capacitance sensor 70 responds to the distance between the arms 52 and 54 of moving arm force responder 50. Alternately, other distance sensing means may be selected by those skilled in the relevant arts. Many known eddy current proximity sensors are suitable for sensing the distance to arms 52 and 54. The combination of a permanent magnet attached to arm 52 and a magnetic field sensor responds to the distance between the magnet and arm 54. It will be appreciated as the description proceeds that the invention may be implemented in different embodiments.

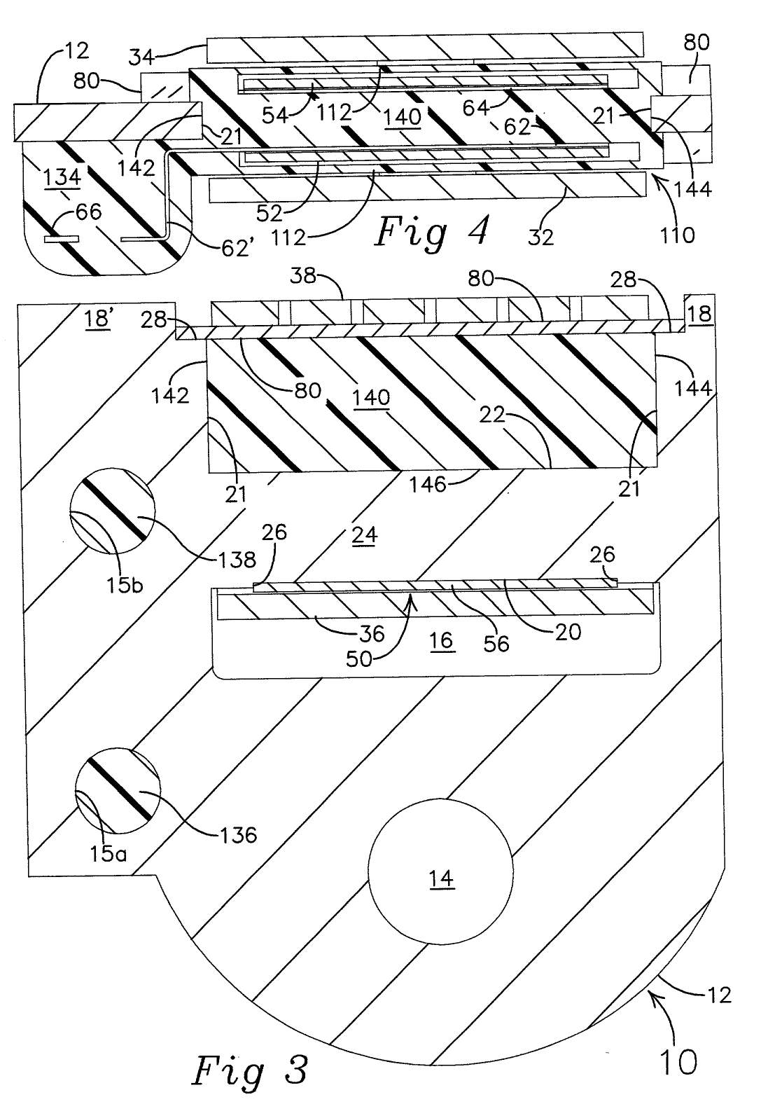

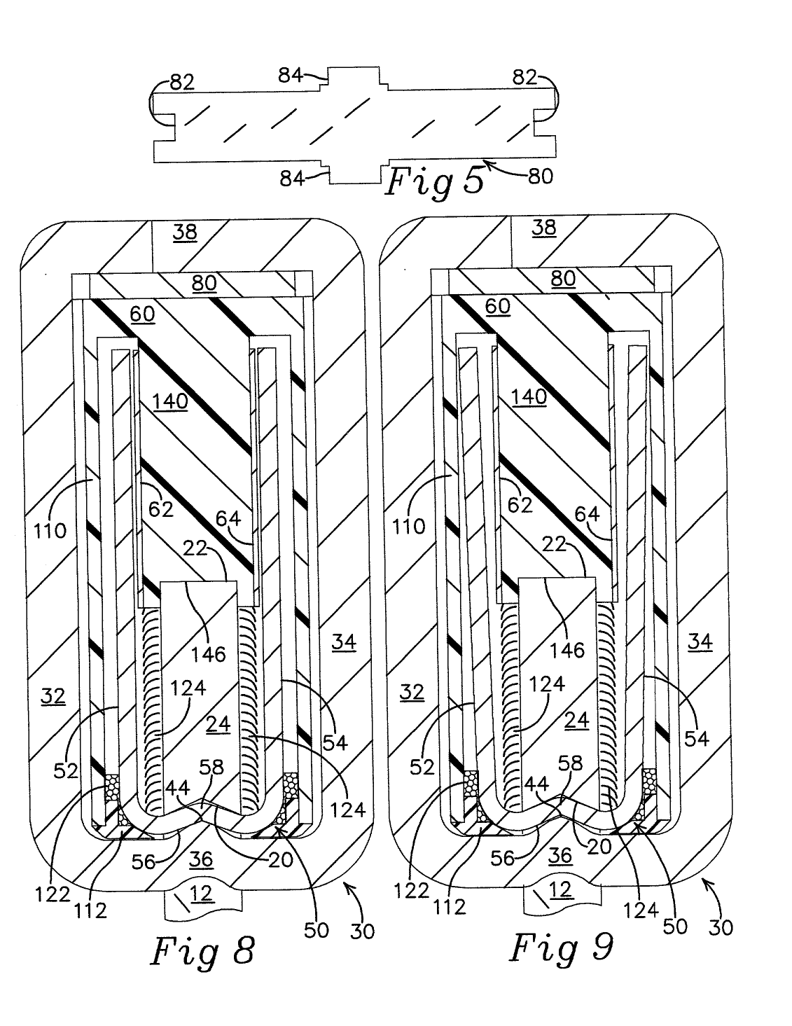

Continuing now the description of seat belt tension sensor 10 with reference to FIGS. 1 through 10. Anchor 12 is a plate having openings 14 15a, 15b, and 16, two preload spring retainers 18 and 18″ rising from ledges 28, and edges 20, 21, and 22. FIG. 3 illustrates the aforementioned openings, retainers, ledges, and edges. Opening 14 accepts shouldered stud 90 for retention by nut 96. Nut 96 tightens against a shoulder (not illustrated) of shouldered stud 90 which enables rotation of anchor 12 about the axis of shouldered stud 90.

Openings 15a and 15b of anchor 12 snugly engage headed fasteners 136 and 138 of connector and distance sensor 60. Opening 16 provides space for passage of a seat belt, force concentrator 36 of seat belt tension receiver 30, and base 56 of moving arm force responder 50. Opening 16 has a grooved edge 20 for engaging base 56 of moving arm force responder 50. Grooved edge 20 and edge 22 define a cross member 24 designed to withstand the largest forces expected during a collision. The groove of edge 20 ends at abutments 26 which keep base 56 of moving arm force responder 50 centrally positioned on edge 20. Preload spring retainers 18 and 18″ and shelves 28 locate and support preload spring 80. Edges 21 and 22 hold capacitor plate carrier 140 in place.

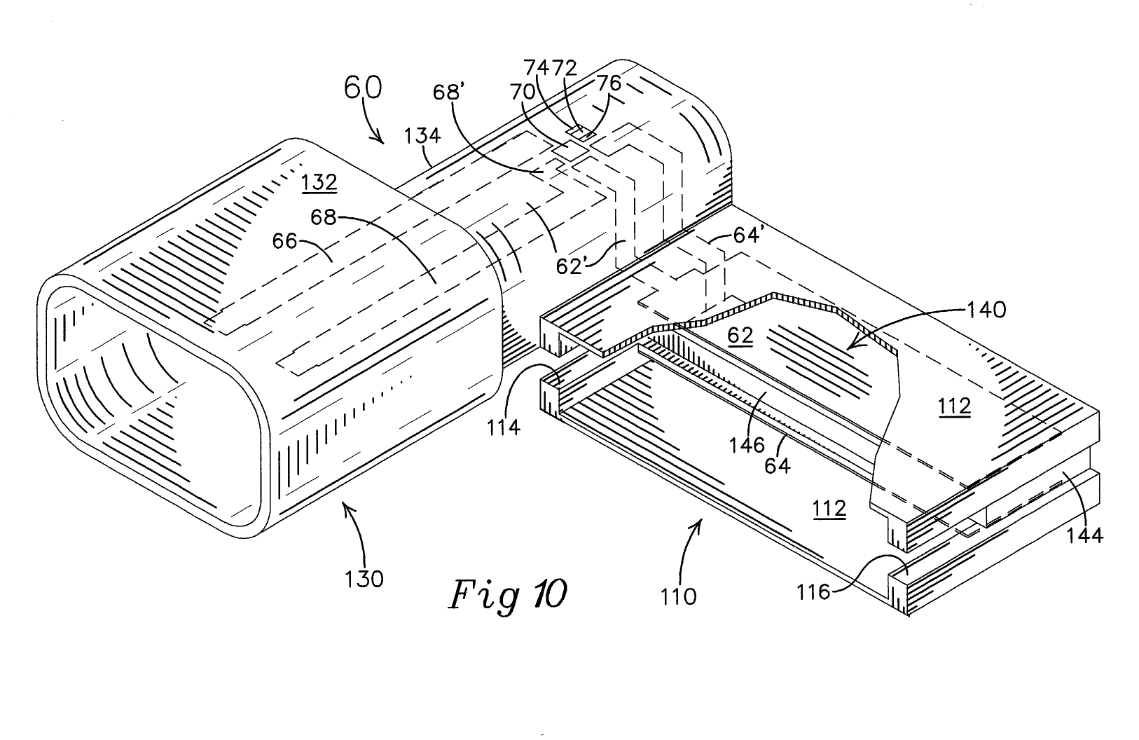

Anchor 12 is preferably cut from steel sheet. Grooved edge 20 is preferably formed by using a cutting tool to achieve a precisely shaped edge. The salient edges of grooved edge 20 are designed to engage base 56 of moving arm force responder 50 over an area sufficient to assure that metal does not yield when forces from seat belt tension reach about one thousand pounds. (Please refer to FIG. 9 for illustration of contact between grooved edge 20 and base 56 of moving arm force responder 50 during large seat belt tension.) HSLA “Navy” steel is believed to be the preferred material for anchor 12 because of its extensive use for seat belt anchors. About ten square millimeters of engagement is appropriate if HSLA steel is used. Other materials and manufacturing methods for making anchor 12 may be substituted by those skilled in the relevant arts.

Seat belt tension receiver 30 receives seat belt tension force and transmits the axial component of the force received from the seat belt to moving arm force responder 50. Seat belt tension receiver 30 also transmits some of the cross axis component of the tension force received from the seat belt to the moving arm force responder 50. Seat belt tension receiver 30 is preferably cut from sheet of the same steel as anchor 12 and bent to form four sides of a rectangular surround. Seat belt tension receiver 30 comprises sides 32 and 34, force concentrator 36, and top 38. Sides 32 and 34 each have an opening 40 or 40′ respectively for receiving a tab 84 of preload spring 80. Force concentrator 36 has a ridge 44 for applying force to the middle of base 56 of moving arm force responder 50. Ridge 44 is preferably as sharp as it can be within the constraint of the need for sufficient area of engagement to prevent overstressing the steel when the aforementioned force of about one thousand pounds is applied. Other materials and manufacturing methods for making seat belt tension receiver 30 may be substituted by those skilled in the relevant arts.

When seat belt tension receiver 30 is made, the bends between sides 32 and 34 and force concentrator 36 are partially completed. This enables side 34 to be inserted through opening 16 during final assembly, followed by completing the bends. Top 38 of seat belt tension receiver 30 comprises short barbed heads 152 with barbs 154 unitary with side 32 and longer barbed heads 162 and 166 with barbs 164 and 168 respectively unitary with side 34. Slots 158 and 160 between long barbed heads 162 and 166 provide flexibility allowing barbed heads 162 and 166 to pass shorter barbed heads 152 when the aforementioned incomplete bends are completed. Barbs 164 and 168 snap together into their illustrated positions whereupon the barbs engage to lock the two parts of top 38 together which holds sides 32 and 34 together. Other means for joining the sides 32 and 34 at top 38 may be substituted by those skilled in the relevant arts.

Moving arm force responder 50 comprises flat spring material formed into a “U” shape having two arms 52 and 54 and a base 56 with a peak 58. Base 56 is shaped to both engage the salient edges of grooved edge 20 of anchor 12 and, also, to receive force from ridge 44 of seat belt tension receiver 30. The reader is referred to FIGS. 8 and 9 for illustrations of the aforementioned features of moving arm force responder 50.

The angle at peak 58 between the two sides of base 56 is determined to minimize relative movement between base 56 and the salient edges of grooved edge 20 when varying seat belt tension causes base 56 to flex. For appreciating that there is an optimum angle at peak 58 it may be helpful to consider that if there were no angle, i.e. if base 56 were flat, the points on base 56 where there is contact with the two salient edges of grooved edge 20 would move away from each other placing different points on the surface of base 56 in contact with the salient edges when the seat belt tension increases and, similarly, would move inward when the tension decreases. Depending on the angle at peak 58, the illustrated shape of peak 58 reduces, eliminates, or reverses the direction of the inward and outward movement. The preferred design is to choose an angle that minimizes the wear of the points of contact over the life of the vehicle. The angle that minimizes or eliminates relative movement is believed to also be the angle that minimizes wear which is preferably determined by using any of the available finite element computer codes for calculating stresses in materials, once the thicknesses of the parts and the properties of the material are known.

The salient edges of edge 20 move slightly inward and outward by virtue of slight flexing of the triangular support underlying the salient edges. The flexing of the triangular support should be taken into account in determining the dimensions that minimize friction and wear. Therefore, modeling should take into account the combination of base 56 of moving arm force responder 50 and the support underlying grooved edge 20 using one of the many aforementioned available finite element modeling computer codes.

Moving arm force responder 50 is preferably made by bending hardened spring steel into a “U” shape and baking it to relieve stress left by bending. For thicker sections a different process may be required. It may be desired to make moving arm force responder 50 of material of such thickness that a small radius at the bends where the arms 52 and 54 join base 56 cannot be achieved with hardened spring material. Such thick material may be required to minimize movement of arms 52 and 54 to better utilize the capabilities of a capacitance distance sensor. Alternately, a lower carbon steel or a stainless steel of a hardness that can be bent as required may be used. Silicon steel other material having soft magnetic properties is preferred when a permanent magnet and magnetic field sensor are used to sense arm position. Beryllium copper offers the advantage, at higher cost, of enabling forming followed by heat treatment at modest temperatures to obtain spring temper. Other materials and manufacturing methods for making moving arm force responder 50 may be selected by those skilled in the relevant arts.

Connector and distance sensor 60 operates to determine the distance between arm 52 and arm 54 by sensing the capacitance between capacitor plates 62 and 64. Connector and distance sensor 60 comprises: electrical connector 130 having connector pins 66 and 68, shroud 132, extension 134, two headed fasteners 136 and 138; capacitor plate carrier 140 having capacitor plates 62 and 64, and grooves 142, 144, and 146; semiconductor capacitance sensor 70; reference capacitor 72 having connection points 74 and 76; electrical conductors 62′ and 64′ for making electrical connection with capacitor plates 62 and 64 respectively; pin extension 68′ for making electrical connection with connector pin 68; and wire bonds 62″, 64″, 66″, 68″, 74″ and 76″. Headed fasteners 136 and 138 are cylindrical bosses molded to fit snugly into openings 15a and 15b of anchor 12 onto which heads are formed after assembly is complete.

Other known means for determining the distance between arms 52 and 54 include eddy current distance sensors and means responsive to variations in a field provided by a permanent magnet which are described herein. Other known means for determining the distance between arms 52 and 54 may be substituted by those skilled in the relevant arts.

Wire bonds 62″ and 64″ connect capacitor plates 62 and 64 with pads on semiconductor capacitance sensor 70 through electrical conductors 62′ and 64′ and respectively. Wire bonds 66″ and 68″ connect connector pins 66 and 68 (through extension 68′) respectively with pads on semiconductor capacitance sensor 70. Wire bonds 74″ and 76″ connect contact points 74 and 76 respectively of reference capacitor 72 with pads on semiconductor capacitance sensor 70.

Capacitor plate carrier 140 is formed when connector and distance sensor 60 is molded. Grooves 142, 144, and 146 are sized to snugly engage edges 21 and 22 of anchor 12. A conformal coating may be applied to insulate capacitor plates 62 and 64 to eliminate the need for capacitance sensor 70 to be able to tolerate grounding of the capacitor plate. Alternately, capacitor plates may be made of aluminum and insulated by anodizing. Other insulating means may be selected by those skilled in the relevant arts.

Connector and distance sensor 60 may also comprise enclosure 110 and cover 120 for enclosing arms 52 and 54 and the capacitor plates 62 and 64. Enclosure 110 is a rectangular box with sides 112, an open end, and cutouts 114 and 116 sized to snugly fit cross member 24 of anchor 20. Cover 120 may have an opening to allow ridge 44 of seat belt tension receiver 30 to contact base 56 of moving arm force responder 50 or it may not have such an opening and be interposed between ridge 44 and base 56. In the Figures the opening is present. A liquid tight seal around moving arm force responder 50 may or may not be desired. The primary purpose of enclosure 110 and cover 120 is believed to be to keep insects from building nests likely to interfere with operation. Keeping insects out only requires enclosure 110 to be resistant to insects but not to be liquid tight.

If a liquid tight seal is required, sealant 122 is placed in cover 120 to make a seal where cover 120 meets enclosure 110, and sealant fillets 124 and 126 (not illustrated) are provided at cutouts 114 and 116 respectively where enclosure 110 intersects cross member 24. In addition to assuring well formed fillets 124 and 126 to obtain a seal the process must not make the thickness of the sealant 122 at cover 120 so thick that it excessively resists movement of the base and arms of moving arm force responder 50. Other materials and manufacturing methods for making connector and distance sensor 60 may be selected by those skilled in the relevant arts.

If cover 120 has no opening it is made of a plastic suitable for withstanding the forces up to one thousand pounds that might repeatedly occur. PET or PEN sheet materials vacuum formed into the required cup shape are believed to be preferred materials for cover 120. It is believed that a preferred sealant may be selected from the many low durometer (i.e. approximately 30 Shore A) two component polyurethane sealants available commercially for many purposes. Master Bond of Hackensack, N.J. provides a product designated EP30D12 which is believed to be suitable. H. B. Fuller of Saint Paul Minn. provides a line of foamed in place materials under the trade name Purform, a low durometer formulation of which is also believed to be suitable.

Connector and distance sensor 60 is preferably made by injection molding a suitable molding compound around the electrical components of connector and distance sensor 60. One process is described in the following: (1) In preparation for molding, capacitor plates 62 and 64, electrical conductors 62 and 64, connector pins 66 and 68, and extension 68′ are cut and formed from a sheet of an electrically conductive material such as gilding metal and held in their final positions relative to each other. (2) The electrical components of connector and distance sensor 60 are electrically connected together by wire bonding. (3) Sufficient potting material is flowed over semiconductor capacitance sensor 70, reference capacitor 72 and the wire bonds 62″, 64″, 66″, 68″, 74″ and 76″ to prevent damage during the injection molding process. (4) The assembly is placed in a mold and plastic molding compound is injected to form connector and distance sensor 60. A preferred molding compound for connector and distance sensor 60 is a mineral or glass fiber filled polyphenylene sulfide molding compound because it makes a strong and dimensionally stable part. Rounded heads are formed on headed fasteners 136 by ultrasonic forming or heat staking whereby electrical connector 130 is attached to anchor 12.

The following modification of the aforementioned process may be substituted to more accurately control the location of capacitor plates 62 and 64 relative to grooves 142, 144, and 146. Prior to injection molding, capacitor plates 62 and 64 are glued to accurately spaced sides of a rectangular spacer. The spacer is preferably porous to enable the molding compound to penetrate the pores of the spacer during injection molding to form a unitary molding. Other materials and methods for making connector and distance sensor 60 may be substituted by those skilled in the relevant arts. Any known position sensor responsive to the distance between moving arms 52 and 54 may be substituted by those skilled in the relevant arts.

Two bearings enable seat belt tension receiver 30 to move with minimal friction over a limited range of axial movement with respect to anchor 12. The first bearing comprises preload spring 80. Preload spring 80 is preferably cut from spring metal sheet to have two notches 82 for engaging preload spring retainers 18 and 18′ of anchor 12 and two tabs 84 for engaging openings 40 and 40′ of seat belt tension receiver 30. In its unstressed shape preload spring 80 is slightly arcuate so that when it is flat as illustrated in FIG. 3 it applies a force to top 38 of seat belt tension receiver 30, the force being sufficient to keep force concentrator 36 of seat belt tension receiver 30, base 56 of moving arm force responder, 50 and grooved edge 20 of anchor 12 in contact with each other to prevent rattling during such as driving over rough roads. The second bearing comprises base 56 of moving arm force responder 50 which flexes to allow axial movement of seat belt tension receiver 30. Other bearings may be substituted by those skilled in the relevant arts.

Shouldered stud 90 comprises a shoulder (not illustrated) of length and diameter determined to mate with opening 14 of anchor 12 and enable rotation of anchor 12 when anchor 12 is retained by nut 96.

A preferred method for manufacturing seat belt tension sensor 10 comprises the following assembly steps: (1) moving arm force responder 50 is placed over cross member 24 and the combination is placed in a fixture designed to hold the two parts in their intended final positions. (2) connector and distance sensor 60 is put onto anchor 12 so that grooves 142, 144 and 146 engage edges 21 and 22 of anchor 12. (3) Optionally, sealant 122 and sealant fillets 124 and 126 are placed and cover 120 is installed. (4) Preload spring 80 is installed on preload spring retainers 18 and 18″ of anchor 12. (5) Side 34 of seat belt tension receiver 30 is passed through opening 16. (6) While preload spring 80 is kept in the flat condition illustrated in FIG. 3, sides 32 and 34 are brought together by completing the bends that were previously only incompletely made. This places opening 40 of side 32 onto a tab 84 of preload spring 80 and opening 40′ of side 34 onto the other tab 84 of preload spring 80. (7) Force is applied at top 34 to bring shorter barbed heads 152 into engagement with longer barbed heads 162 and 166 to close the four sides of seat belt tension receiver 30 and 30 make the assembly permanent. Other manufacturing methods for making seat belt tension sensor 10 may be substituted by those skilled in the relevant arts.

The materials and methods referred to hereinabove are only suggestions and others may be substituted by those skilled in the relevant arts.

The operation of the seat belt tension sensor 10 of the invention will now be described with reference to FIGS. 1 through 10. In operation of the system, when a seat belt applies force from seat belt tension to force concentrator 36 of tension receiver 30, the axial component of the force from seat belt tension is applied by ridge 44 of seat belt tension receiver 30 to the underside of peak 58 of base 56 of moving arm force responder 50 causing the salient edges of edge 20 of anchor 12 to apply an equal and oppositely directed force to base 56. Base 56 of moving arm force responder 50 flexes slightly under the stress which causes arms 52 and 54 to move farther from each other which decreases the capacitance between capacitor plates 62 and 64.

Semiconductor capacitance sensor 70 senses the capacitance between capacitor plates 62 and 64. To a first approximation, the capacitance between capacitor plates 62 and 64 varies inversely with the sum of the thicknesses of the two air gaps between capacitor plate 62 and arm 52 and between capacitor plate 64 and arm 54. Accordingly, the capacitance measured by semiconductor capacitance sensor 70 is a measure of a sum of distances which increases as base 56 of moving arm force responder 50 is increasingly stressed. The flexing of base 56 of moving arm force responder 50 is proportional to the force applied by ridge 44 of seat belt tension receiver 30 to the middle of base 56 of moving arm force responder 50. Accordingly, if the output of semiconductor capacitance sensor 70 indicates sensed capacitance, the output also indicates the inverse of the force applied by seat belt tension receiver 30 to base 56 of moving arm force responder 50. The output of semiconductor capacitance sensor 70 is transmitted through connector pins 66 and 68 and other conductors to the microprocessor of the occupant protection system (not illustrated) of the vehicle which indicates to the processor the force being applied to moving arm force responder 50.

A preferred process for ascertaining the force being applied to base 56 of moving arm force responder 50 is the following: The microprocessor or internal circuitry of the capacitance sensor: (1) measures the capacitance between capacitor plates 62 and 64, (2) From a table stored in the capacitance sensor after seat belt tension sensor 10 is assembled, the capacitance sensor obtains the axial component of the seat belt tension force the seat belt is applying to seat belt tension receiver 30 and transmits that measurement of the seat belt tension to the microprocessor of the occupant protection system of the vehicle.

When forces up to such as one thousand pounds are applied to base 56 of moving arm force responder 50, base 56 flexes but is not stressed beyond its yield stress. At a predetermined force that is much less than the aforementioned one thousand pounds, base 56 of moving arm force responder 50 flexes sufficiently that the angle at peak 58 is equal to the angle at the middle of grooved edge 20 of anchor 12 whereupon base 56 abuts the bottom of the grooved edge 20 of cross member 24 over much or most of its area and grooved edge 20 prevents further flexing of base 56 of moving arm force responder 50 and, thereby, the stress in base 56 is limited to a stress below its yield stress. FIG. 9 illustrates base 56 engaging the bottom of the groove 20 of cross member 24 over much of its area for limiting the stress experienced by base 56.

When the seat belt tension applied to seat belt tension sensor 10 has a cross axis component (“cross axis” is used herein to denote directions perpendicular to the axis indicated by arrow 184 in FIG. 2) in a direction such as the direction indicated by arrow 184′, the cross axis force acts principally on the top of tension receiver 30 near bearing and preload spring 80 and urges the top of tension receiver 30 in the direction of the cross axis force. Movement in a cross axis direction is resisted by preload spring 80 because preload spring retainers 18 and 18′ of anchor 12 fix the location of preload spring 80, and openings 40 and 40′ in sides 32 and 34 engage tabs 84 of preload spring 80. Cross axis movement of the lower part of seat belt tension receiver 30 is prevented by engagement between ridge 44 of force concentrator 36 of seat belt tension receiver 30 and the underside of peak 58 of base 56 of moving arm force responder 50 which, in turn, engages grooved edge 20 of anchor 12. Accordingly, there are low friction two bearings for movement in the axial direction (indicated by arrow 184) whereby the output of seat belt tension sensor 10 is minimally affected by friction. The low friction enables seat belt tension sensor 10 to be an accurate sensor of the axial component of seat belt force and, further, to be minimally affected by seat belt tension force applied by the seat belt in cross axis directions.

Preferably, the semiconductor capacitance sensor 70 is a semiconductor sensor of the type that includes programmable memory elements in which values of parameters can be stored by inputting digital signals specifying the values of the parameters. The parameters are determined and stored after the seat belt and tension sensor 10 is completely assembled. The parameters are determined by performing the following procedure: After the seat belt tension sensor 10 is assembled it is connected to test apparatus that reads the output of connector and distance sensor 60 while no force is applied to seat belt tension sensor 10. Then a force simulating a seat belt tension of such as ten pounds is applied between tension receiver 30 and anchor 12 and the output of connector and distance sensor 60 is again read. Based on the readings at the applied forces of zero and ten pounds and knowledge of the inner workings of capacitance sensor 70 parameters are stored in semiconductor capacitance sensor 70 that cause it to output a low voltage such as one volt when no tension is applied and a higher voltage such as four volts when a seat belt tension such as thirty pounds is applied, thereby providing compensation for manufacturing variations in preload spring tension, capacitance between capacitor elements, resiliency of the material of moving arm force responder 50, and other variables.

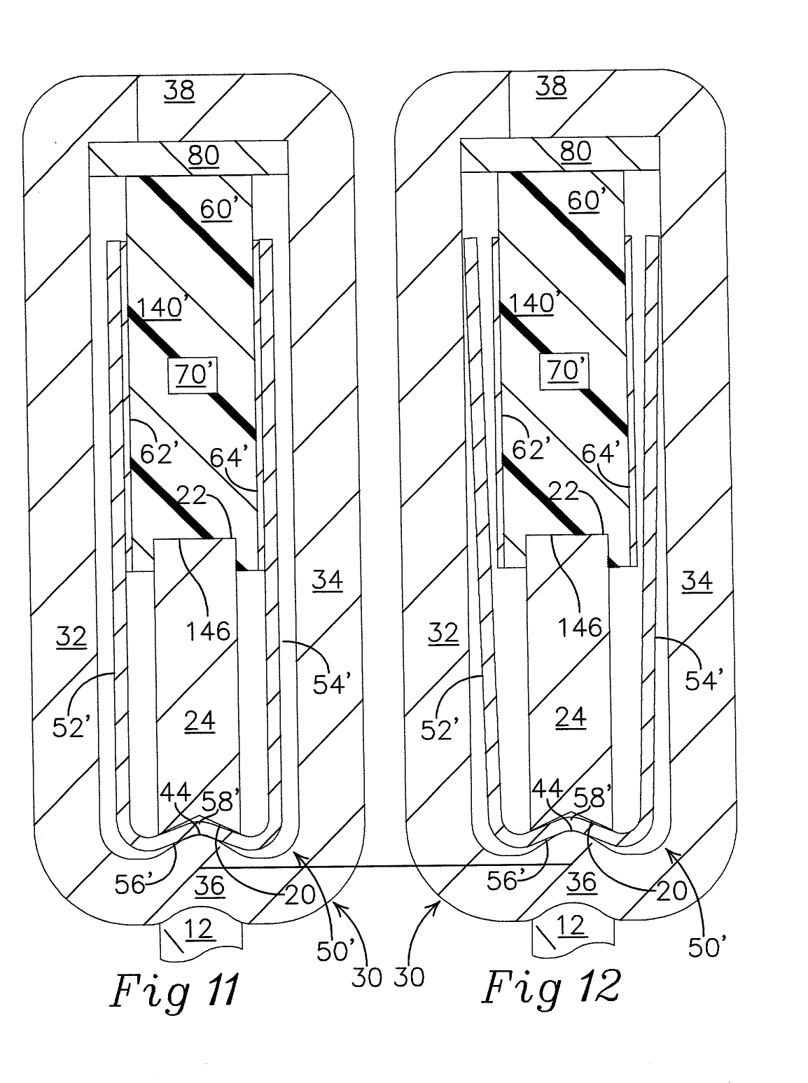

Certain embodiments of the seat belt tension sensor of the invention will now be described with reference to FIGS. 11 and 12. The embodiments illustrated in FIGS. 11 and 12 are similar to the embodiment illustrated in FIGS. 1 through 10 but the design is simplified by omission of enclosure 110. This is done to illustrate a simplified design. Whether or not enclosure 110 and cover 120 are included depends on whether or not fluid penetration, insect nesting, or debris accumulation must be guarded against.

Many of the parts of the embodiments of the invention illustrated in FIGS. 11 and 12 are or may be the same as the corresponding embodiments of the invention illustrated in FIGS. 1 through 10 and those parts are numbered with the same numbers. The parts that may be different are moving arm force responder 50′ comprising arms 52′ and 54′, base 56′ and peak 58′, connector and distance sensor 60′ comprising plates 62′ and 64′, sensing element 70′, and plate carrier 140′.

Several simplified embodiments of the seat belt tension sensor of the invention are illustrated by FIGS. 11 and 12. In a first simplified embodiment, element 70′ is omitted and plates 62′ and 64′ may be the same as plates 62 and 64 illustrated in FIG. 1 through 10 and are connected to capacitance sensor 70 as illustrated in FIGS. 1 through 10. The operation of this embodiment is the same as the operation of the embodiments of the invention described hereinabove with reference to FIGS. 1 through 10.

Connector and distance sensor 60′ of the first simplified embodiment may be the same as connector and distance sensor 60′ of the first embodiment illustrated in FIGS. 1 through 10 or it may be modified to present an output signal having only two levels. If it is modified to present an output signal having only two levels, then the microprocessor of the occupant protection system is programmed to accept a signal indicating the seat belt tension is less than or greater than the predetermined force.

In a second simplified embodiment of the seat belt tension sensor of the invention illustrated in FIGS. 11 and 12, element 70 is omitted and plates 62′ and 64′ are electrically connected directly to connector pins 66 and 68. In this embodiment arms 52′ and 54′ and plates 62′ and 64′ all operate as electrical contacts so that there is electrical continuity between connector pins 66 and 68 when there is no seat belt tension as illustrated in FIG. 11 and there is no electrical continuity between connector pins 66 and 68 when seat belt tension is greater than a predetermined seat belt tension as illustrated in FIG. 12. This design enables an occupant protection system processing unit to distinguish between a tightly belted child seat and a normally seated adult when a weight sensor senses a weight that could be either. For this second simplified embodiment moving arm force responder 50′ may be made of thinner material than moving arm force responder 50 and bent so that when no seat belt force is applied, arms 62′ and 64′ are pressing against plates 62′ and 64′.

The operation of the second simplified embodiment of the seat belt tension sensor of the invention will now be described with reference to FIGS. 11 and 12. When the seat belt tension is less than a predetermined seat belt tension, the arms 52′ and 54′ remain in the position illustrated in FIG. 11 wherein they rest against plates (contacts) 62′ and 64′. The effect of seat belt tensions less than the predetermined seat belt tension is to reduce the force applied by the arms 52′ and 54′ to plates (contacts) 62′ and 64′ and there is no movement and there is electrical continuity between connector pins 66 and 68.

When seat belt tension exceeds the predetermined seat belt tension it causes a force to be applied to base 56′ sufficient to overcome the stress formed into base 56′ during its manufacture and cause it to flex. The force causes arms 52′ and 54′ to move away from plates (contacts) 62′ and 64′ toward the positions illustrated in FIG. 12. This causes an open circuit between connector pins 66 and 68.

When arms 52′ and 54′ are in the positions illustrated in FIG. 12, the open circuit between connector pins 66 and 68 indicates seat belt tension receiver 30 is applying a force greater than the predetermined seat belt tension to moving arm force responder 50.

In a third simplified embodiment of the seat belt tension sensor of the invention illustrated in FIGS. 11 and 12, plates 62′ and 64′ are thin sheets of permanent magnet material magnetized perpendicular to the flat surfaces of the sheets. Plates 62′ and 64′, alternately, may be attached to the arms 52′ and 54′ of moving arm force responder 50. Element 70′ is a magnetic field sensor such as a Hall effect sensor or a magnetoresistive sensor insert molded into carrier 140′ where its sensing area is centrally located between the two sheets of permanent magnet material 62′ and 64′. Element 70′ (the magnetic field sensor) is connected to connector pins 66 and 68. Moving arm force responder 50 is made of a high permeability material such as silicon steel of the type used for transformer cores. The magnetic field sensor senses a magnetic field approximately proportional the inverse of the distance between the two arms of moving arm force responder 50 and transmits a signal responsive to that distance to the occupant protection system of the vehicle.

The operation of the third simplified embodiment of the seat belt tension sensor of the invention will now be described with reference to FIGS. 11 and 12. Seat belt tension applied to seat belt tension receiver 30 causes force to be applied to base 56′ which causes it to flex. The force causes arms 52′ and 54′ to move away from plates 62′ and 64′ toward the positions illustrated in FIG. 12. This causes the magnetic field at element 70′ (the magnetic field sensor) to diminish approximately as the inverse of the distance between arms 52′ and 54′. Accordingly, the output of element 70′ (the magnetic field sensor) indicates the seat belt tension. The indication may be analog or digital to indicate values of the seat belt tension or it may be binary to indicate if the seat belt tension is or is not above a predetermined level.

If the output is binary, when arms 52′ and 54′ are in the positions illustrated in FIG. 12, element 70′ responds to the lower magnetic field between plates 62′ and 64′ by providing an electric signal to connector pins 66 and 68 indicating seat belt tension receiver 30 is applying a force greater that the predetermined force to moving arm force responder 50.

A fourth alternate simplified embodiment of the seat belt tension sensor of the invention illustrated in FIGS. 11 and 12 is achieved by making element 70′ an inductive coil located in the central plane of carrier 140 in combination with an inductance sensor connected to measure the inductance of the coil. The inductance of the coil is approximately proportional the inverse of the distance between the two arms of moving arm force responder 50. The inductance sensor, therefore, transmits a signal responsive to that distance to the occupant protection system of the vehicle.

A difference between the two aforementioned alternate distance sensing means and capacitive distance sensing is that capacitive position sensing responds to very small distances between the arms of moving arm force responder 50 and capacitor plates 62 and 64 so that it respond to very small movements whereas the electromagnetic measuring systems perform better when measuring larger movements. These differences may make one or the other of the distance sensors advantageous depending on the requirements the seat belt tension sensing system must meet.

Although the description of this invention has been given with reference to particular embodiments, it is not to be construed in a limiting sense. Many variations and modifications will now occur to those skilled in the art. For a definition of the invention reference is made to the appended claims.

What is claimed is:

1. A seat belt tension sensor comprising:
a cross member,
a force sensing means, and
a tension receiver, and wherein:
said tension receiver is adapted for receiving force from a seat belt,
said tension receiver is connected with said force sensing means for applying force thereto,
said force sensing means is connected with said cross member for applying force thereto, and
said force sensing means is adapted to generate an electric signal responsive to said force received from said tension receiver when said force received from said tension receiver is in the range of zero to a predetermined force, and including
means for protecting said force sensing means from damage by said force when said force received from said seat belt is greater than said predetermined force.

2. The invention as defined by claim 1 and wherein
said tension receiver is movable in the direction of an axis, and including:
means for selecting from said force received from a seat belt the component of said force received from a seat belt having the direction of said axis, and wherein:
said tension receiver is adapted to apply said selected component of said force through said connection to said force sensing means.

3. The invention as defined by claim 2 wherein:
said means for selecting said axial component comprises bearing means providing low friction movement of said tension receiver in the direction of said axis.

4. The invention as defined by claim 3 and wherein:
said bearing means comprises flexible suspension means engaging said anchor and said tension receiver.

5. The invention as defined by claim 4 wherein:
said flexible suspension means provides a preload force urging said tension receiver in the direction of said axis.

6. The invention as defined by claim 1 wherein:
said force sensing means comprises a flexible member,
said flexible member is connected with said tension receiver for receiving force therefrom, and
said flexible member is adapted to flex in response to said force received from said tension receiver.

7. The invention as defined by claim 6 wherein:
said electric signal is a measure of said flexing of said flexible member.

8. the invention as defined by claim 6, and wherein:
said cross member comprises a grooved edge,
said grooved edge comprises salient edges,
said flexible member engages said salient edges,
at times when said force received by said flexible member from said tension receiver is less than said predetermined force there is a gap delimited by said salient edges between said flexible member and said groove, and
said flexible member and said groove are such that: when said force received by said flexible member from said tension receiver is greater than said predetermined level, said flexible member and said groove abut at points between said salient edges.

9. The invention as defined by claim 6 wherein:
said flexible member comprises a base adapted to flex in response to said force received from said tension receiver, and including:
two arms linked with said base for movement consequent to said flexing, and wherein:
said two arms have a distance therebetween,
said distance between said arms is responsive to said force received by said flexible member from said tension receiver, and
said force sensing means comprises means responsive to said distance between said arms by generating said electric signal.

10. The invention as defined by claim 9 and including:
a capacitance sensor and two capacitor elements, and wherein:
there is a first capacitance between one of said two capacitor elements and one of said two arms, said arms being electrically connected,
there is a second capacitance between the other of said two capacitor elements and the other of said two arms,
said capacitance sensor is connected to said capacitor elements for sensing the capacitance therebetween, and
said capacitance sensor is adapted for generating a signal responsive to said capacitance between said capacitor elements, whereby
said signal is said electric signal.

11. The invention as defined by claim 9 and including:
a permanent magnet for providing a magnetic field between said arms, and
a magnetic field sensor responsive to said magnetic field, and wherein:
said arms comprise ferromagnetic material, and
said magnetic field sensor is adapted for generating a signal responsive to said magnetic field between said arms, whereby
said signal is said electric signal.

12. A belt tension sensor comprising:
an anchor, said anchor comprising a cross member,
a flexible member,
a tension receiver, and
sensing means for generating an electric signal, and wherein:
said flexible member is connected with said cross member for applying force thereto,
said tension receiver is adapted for receiving belt tension,
said tension receiver is connected with said flexible member for applying thereto force derived from said belt tension,
said flexible member is responsive to said force received from said tension receiver by flexing, and
said sensing means is responsive to said flexing of said flexible member by generating said electric signal.

13. The invention as defined by claim 12, including
means for selecting the component of said force from a belt received by said tension receiver in the direction of an axis from other components of said force from a belt received by said tension receiver, and wherein:
said tension receiver is movable with respect to said anchor in the direction of said axis, and
said force applied to said flexible member by said tension receiver comprises said axial component.

14. The invention as defined by claim 13 and including:
low friction bearing means for bearing said movement of said tension receiver relative to said anchor in the direction of said axis, and wherein:
said means for selecting comprises said bearing means.

15. The invention as defined by claim 14 wherein:
said low friction bearing means comprises a first flexible suspension means engaging both said anchor and said tension receiver.

16. The invention as defined by claim 12 and including:
an arm, and wherein:
said flexible member is linked with said arm for moving said arm consequent to said flexing, and
said sensing means is responsive to the position of said arm.

17. The invention as defined by claim 16 and including:
a capacitor element, and wherein
said sensing means responds to capacitance between said capacitor element and said arm by generating said electric signal.

18. A force sensor comprising:
a tension receiver, and
a moving arm force responder, and wherein:
said moving arm force responder comprises a base adapted to receive force from said tension receiver,
said moving arm force responder also comprises two arms, there is a distance between said arms, and said distance depends on said force received from said tension receiver, and including
means responsive to said distance by generating an electric signal indicating said force received from said tension receiver.

19. The invention as defined by claim 18 and including:
a capacitance sensor and two capacitor elements, and wherein:
there is a first capacitance between one of said two capacitor elements and one of said two arms, said arms are electrically connected,
there is a second capacitance between the other of said two capacitor elements and the other of said two arms,
said capacitance sensor is connected to said capacitor elements for sensing the capacitance therebetween,
said capacitance sensor is adapted to generate a signal responsive to said capacitance between said capacitor elements, and
said signal is said electric signal.

20. The invention as defined by claim 18 and including:
a permanent magnet and a magnetic field sensor, and wherein:
said permanent magnet provides a magnetic field between said arms,
said magnetic field depends on said distance,
said magnetic field sensor is adapted to generate a signal responsive to said magnetic field between said arms, and
said signal is said electric signal.

21. The invention as defined by claim 18 and including:
an anchor comprising a cross member, and wherein:
said cross member comprises a grooved edge,
said grooved edge comprises salient edges, and
said base engages said salient edges.

22. The invention as defined by claim 21 wherein:
said base is adapted to flex in response to said force received from said tension receiver, and
said base and said groove are adapted to minimize friction between said base and said salient edges during said flexing.

23. The invention as defined by claim 21 wherein;
when said force received from said tension receiver is small, a gap delimited by said salient edges exists between said base and said groove, and
there is a predetermined level of said force received from said tension receiver above which said base and said groove abut at points between said salient edges.

24. The invention as defined by claim 18, and including:
an anchor, and
a first bearing means, and wherein:
said tension receiver is movable in the direction of an axis,
said first bearing means bears said tension receiver in said movement, and
said first bearing means comprises first flexible suspension means engaging said anchor and said tension receiver.

25. The invention as defined by claim 24 wherein:
said first flexible suspension means is adapted to apply a preload force urging said tension receiver in the direction of said axis.

26. The invention as defined by claim 24, and including:
a second bearing means, and wherein:
said second bearing means bears said tension receiver in said movement, and
said second bearing means comprises said base of said moving arm force responder engaging both said grooved edge of said anchor and said tension receiver.
